(19) United States
(12) Patent Application Publication
(10) Pub. No.: US 2013/0134100 A1
(43) Pub. Date: May 30, 2013

(54) Compacted Filter Beds Comprising Non-Sintered, Buoyant Filter Media and Methods Relating Thereto

(71) Applicant: Celanese Acetate LLC, Irving, TX (US)

(72) Inventors: Christopher McGrady, Florence, KY (US); Dian Chen, Florence, KY (US); Bernard Jason Smith, Cincinnati, OH (US); Julia Hufen, Rheinberg (DE); Suresh Subramonian, Midland, MI (US); Rainer Walkenhorst, Melle (DE); Joseph D. Cohen, Denver, CO (US)

(73) Assignee: Celanese Acetate LLC, Irving, TX (US)

(21) Appl. No.: 13/653,637

(22) Filed: Oct. 17, 2012

Related U.S. Application Data
(60) Provisional application No. 61/629,710, filed on Nov. 28, 2011.

(51) Int. Cl. B01D 24/46

(52) U.S. Cl. CPC B01D 24/46
USPC 210/678; 210/793; 210/764; 210/275

(57) ABSTRACT

Compacted filter beds comprising a non-sintered, buoyant filter medium may be useful in fluid filtration apparatuses and methods. For example, a method may include filtering a first fluid through a filter bed that is compacted, the filter bed comprising a non-sintered, buoyant filter medium that is mechanically compacted; and backflushing a second fluid through the filter bed so as to fluidize the non-sintered, buoyant filter medium.

### CROSS REFERENCE TO RELATED APPLICATION

The present application claims priority to U.S. Provisional Application No. 61/629,710 filed on Nov. 28, 2011 entitled “Mechanical Compaction of Granular Polyethylene for Fluid Filtration.”

### BACKGROUND

The present invention relates to compacted filter beds comprising a non-sintered, buoyant filter medium and methods related thereto.

Fluid filtration apparatuses use filter beds that comprise filter media to filter impurities from an influent fluid (e.g., trap particulate matter and/or adsorb organic compounds). Filter beds can generally be classified into two types: sintered (or bonded) media or non-sintered (non-bonded) media. Bonded filter media is often polymer particles fused together or fibrous woven or nonwoven material that are bonded but have a given porosity. When the sintered filter media has a sufficient accumulation of impurities from an influent fluid, the filter bed (often in a filter cartridge) is removed from the filtration apparatus and replaced. In some instances, the filter bed can be cleaned using a secondary apparatus.

Non-sintered filter media, on the other hand, is often particulate matter (e.g., sand or diatomaceous earth) where the porosity is derived from the packing configuration of the particulates and the spacing between the non-bonded filter media. When the non-sintered filter media has a sufficient accumulation of impurities from an influent fluid, a backwash fluid can be flowed in the opposite direction of the influent fluid, thereby fluidizing the non-sintered filter media, and consequently separating the non-sintered media from the trapped impurities (e.g., dislodging particles trapped therein and/or cleaning the organic matter adsorbed to the surface of the non-sintered filter media).

The materials used for non-sintered filter media are often negatively buoyant materials (i.e., materials that sink in water) like sand, diatomaceous earth, or glass beads, that compact to form filter beds (sometimes referred to as filter cakes) as a result of the pressure differential across the filter bed. However, as a consequence of the filter media being non-bonded, the filter media can shift, which often leads to cracks in the filter bed. These cracks are more evident as particle size decreases because the pressure differential across the filter bed increases in response to the correspondingly smaller pore sizes. Accordingly, a need exists for efficient small particle filtration using non-bonded media.

### SUMMARY OF THE INVENTION

The present invention relates to compacted filter beds comprising a non-sintered, buoyant filter medium and methods related thereto.

One embodiment of the present invention provides for a method that includes filtering a first fluid through a filter bed that is compacted, the filter bed comprising a non-sintered, buoyant filter medium that is mechanically compacted; and backflushing a second fluid through the filter bed so as to fluidize the non-sintered, buoyant filter medium.

Another embodiment of the present invention provides for a method that includes filtering a first fluid through a filter bed that is compacted, the filter bed comprising a non-sintered, buoyant filter medium having a popcorn shape that is mechanically compacted; and backflushing a second fluid through the filter bed so as to fluidize the non-sintered, buoyant filter medium.

Yet another embodiment of the present invention provides for a method that includes filtering a first fluid through a filter bed that is compacted, the filter bed comprising a non-sintered, buoyant filter medium that is mechanically compacted, the non-sintered, buoyant filter medium comprising high to ultrahigh molecular weight polymers selected from the group consisting of polyethylene, polypropylene, polybutylene, polyethylene-co-polybutylene, polyethylene-co-polypropylene, polyethylene-co-polybutylene, and any blend thereof; and backflushing a second fluid through the filter bed so as to fluidize the non-sintered, buoyant filter medium.

Another embodiment of the present invention provides for a filtration apparatus that includes a compacted filter bed that comprises a non-sintered, buoyant filter medium; and a configuration that allows for the non-sintered, buoyant filter medium to fluidize during backflush.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1A provides a representative scanning electron micrograph of high density polyethylene particles utilized in the examples provided herein.

FIG. 1B provides a representative scanning electron micrograph of ultrahigh molecular weight polyethylene particles having a potato shape.

FIG. 1C provides a representative scanning electron micrograph of ultrahigh molecular weight polyethylene particles having a popcorn shape.

FIG. 2 provides an illustration of interlocking popcorn-shaped particles as described herein.

FIG. 3 provides an illustration of a filtering method according to at least one embodiment described herein.

### DETAILED DESCRIPTION

The present invention relates to compacted filter beds comprising a non-sintered, buoyant filter medium and methods related thereto.

The present invention provides for, in some embodiments, non-sintered, buoyant filter media that enables small particle filtration and backflushing to rejuvenate the filter bed. It should be noted that while small particle filtration may be enabled, larger particle filtration may, in some embodiments, also be applicable. As used herein, the term “non-sintered” when referring to filter media refers to particles that are not fused together.

In some embodiments, the buoyancy of the filter media may enable faster, more efficient backflushing steps because the filter media may fluidize faster and with lower backflush flow rates. Further, in some embodiments, the non-sintered, buoyant filter media described herein may advantageously be compressible (as opposed to rigid as described above), which in combination with mechanical compaction of the filter bed enables smaller pore sizes for similarly sized particles (i.e., compressible versus rigid). As used herein, the term “buoyant” refers to a material or particle having a specific gravity less than about 1.0.

Further, the present invention provides for, in some embodiments, non-sintered, buoyant filter media that synergistically combines the buoyancy, compressibility, and shape so as to enable interlocking particles during filtration (i.e., under compaction), which further mitigates crack formation and enables smaller pore sizes for more efficient and effective filtration. Additionally, during backflushing, the non-sintered, buoyant filter media may be fluidized into individual particles to enable efficient and effective regeneration of the filter bed.

It should be noted that when “about” is provided herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, the non-sintered, buoyant filter media described herein may comprise at least one polymer of: polyethylene, polypropylene, polybutylene, polyethylene-co-polybutylene, polyethylene-co-polypropylene, polypropylene-co-polybutylene, and the like, and any blend thereof. In some embodiments, the non-sintered, buoyant filter media described herein comprising such polymers may advantageously be elastic particles that in the compacted filter beds described herein are compressed to yield smaller pore sizes (e.g., as compared to sand or diatomaceous earth) for a similar average particle size and substantially rebound in shape when the compaction is released during backwashing.

In some embodiments, the polymers of the non-sintered, buoyant filter media may be a high to ultrahigh molecular weight polymer of at least one of: polyethylene, polypropylene, polybutylene, polyethylene-co-polybutylene, polyethylene-co-polypropylene, polyethylene-co-polybutylene, and the like, and any blend thereof. As used herein, the term “high to ultrahigh molecular weight polymer” should be taken to encompass high molecular weight polymer, very-high molecular weight polymer, ultrahigh molecular weight polymer, and any blend thereof. As used herein, the term “high molecular weight polymer” refers to a polymer composition having an average molecular weight of about 300,000 g/mol to about 1,000,000 g/mol. As used herein, the term “very-high molecular weight polymer” refers to a polymer composition having an average molecular weight of about 1,000,000 g/mol to about 3,000,000 g/mol. As used herein, the term “ultrahigh molecular weight polymer” refers to a polymer composition having an average molecular weight of about 3,000,000 g/mol to about 20,000,000 g/mol.

In some embodiments, the non-sintered, buoyant filter media described herein may comprise composite particles that comprise a polymer (e.g., those described above) and an active agent, which may, for example, beneficially participate in the adsorption of organic contaminants from the filter fluid. As used herein, the term “composite particle” refers to a particle of two or more materials that are not miscible (e.g., not polymer blends, but rather polymers plus solid agents like graphite). Examples of active agents may, in some embodiments, include, but are not limited to, activated carbon of any activity (e.g., carbon capable of 60% CCl₄ adsorption), graphite, ion exchange resins, silicates, molecular sieves, silica gels, activated alumina, zeolites, mineral materials (e.g., perlite, sepiolite, magnesium silicate, and the like), Fuller's Earth, antimicrobial agents (e.g., silver particles), and the like, and any combination thereof. By way of nonlimiting example, the non-sintered, buoyant filter media described herein may comprise composite particles that comprise ultrahigh molecular weight polyethylene and activated carbon.

In some embodiments, the non-sintered, buoyant filter media described herein may have an average particle size (“d₅₀”) in at least one dimension ranging from a lower limit of about 1 micron, 10 microns, 50 microns, 100 microns, 150 microns, 200 microns, and 250 microns to an upper limit of about 5000 microns, 2000 microns, 1000 microns, 750 microns, 500 microns, 400 microns, 300 microns, 250 microns, 200 microns, 150 microns, or 100 microns, and wherein the average particle size may range from any lower limit to any upper limit and encompasses any subset therebetween.

In some embodiments, the non-sintered, buoyant filter media described herein may have a bulk density ranging from a lower limit of about 0.10 g/cm³, 0.25 g/cm³, or 0.5 g/cm³ to an upper limit of less than 1.0 g/cm³, about 0.9 g/cm³, 0.75 g/cm³, or 0.5 g/cm³, and wherein the bulk density may range from any lower limit to any upper limit and encompasses any subset therebetween (e.g., 0.10 g/cm³ to about 0.30 g/cm³).

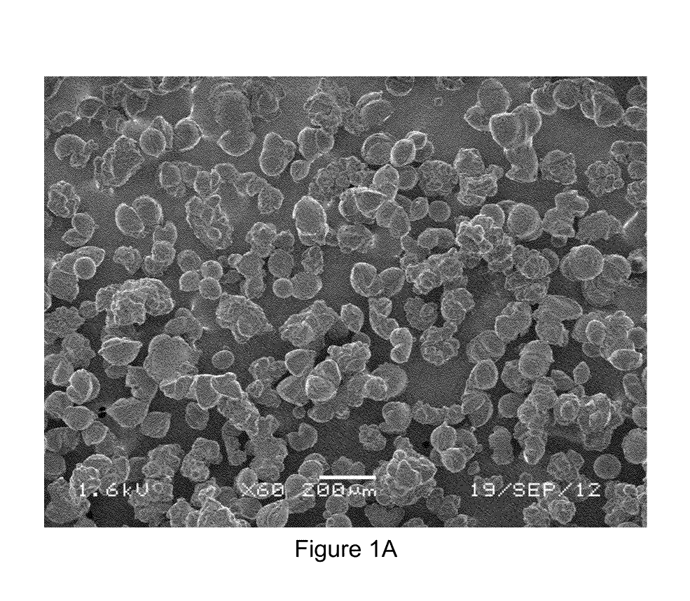

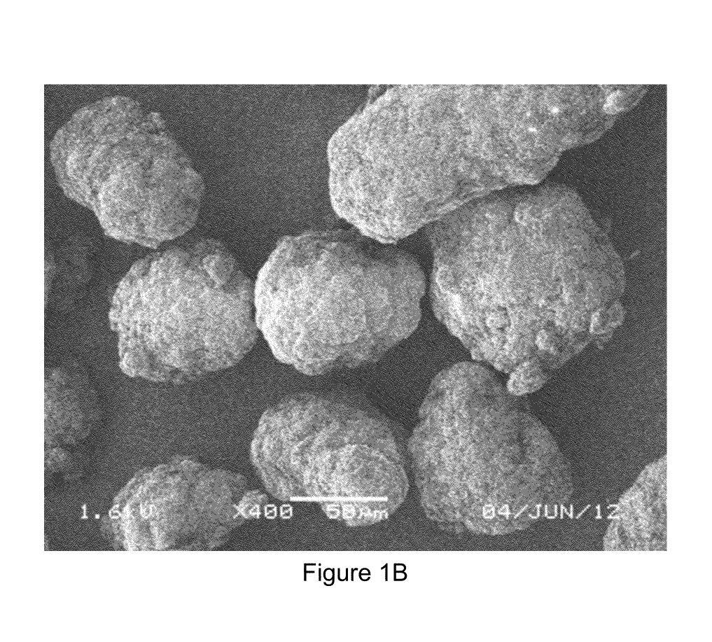

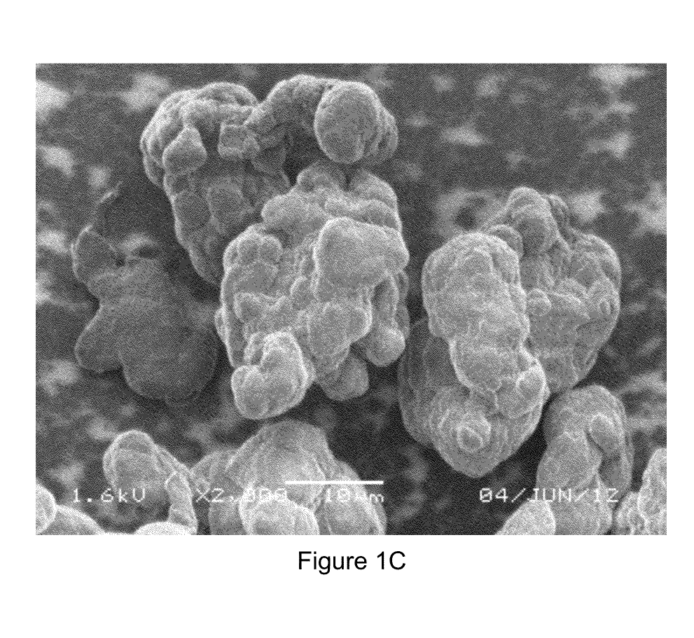

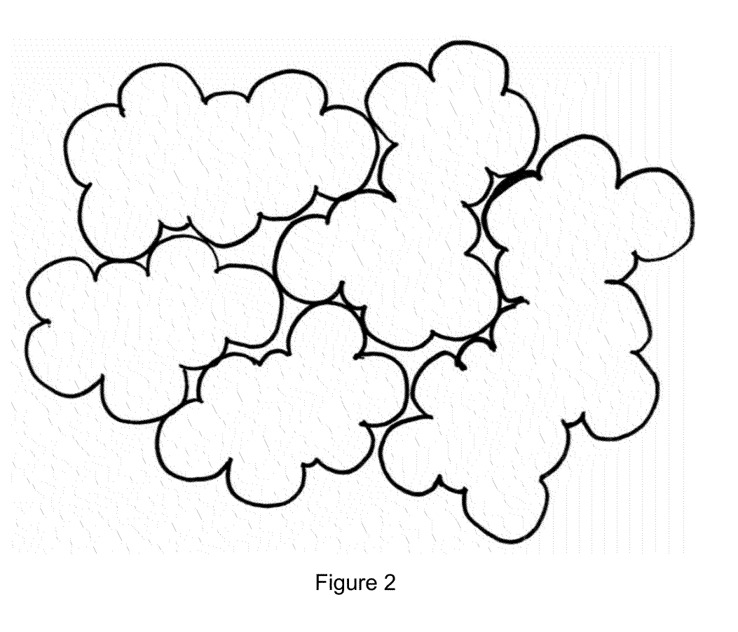

In some embodiments, the non-sintered, buoyant filter media described herein may have a desired shape to create the desired porosity when compacted. Examples of shapes may, in some embodiments, include, but are not limited to, spherical, substantially spherical, ovular, substantially ovular, prolate, globular, potato (as shown in FIG. 1B), substantially potato, popcorn, substantially popcorn, discus, platelet, flake, acicular, polygonal, randomly shaped, and any hybrid thereof. As used herein, a “popcorn” shape refers to particles that are generally spherical, ellipsoidal, prolate, or globular with a bulbous surface, e.g., as shown in FIG. 1C and FIG. 2. Popcorn shaped non-sintered, buoyant filter media may be preferred in some embodiments.

In some embodiments, the non-sintered, buoyant filter media described herein having a popcorn shape may, in some embodiments, advantageously enable the non-sintered, buoyant filter media to fit together in an interlocking manner, e.g., as illustrated in FIG. 2, which may be enhanced by the pressure applied during filtration. The interlocking nature of the particles enables the pore sizes of the filter media mass to be smaller, thus increasing the effectiveness of the filtering. Additionally, the compressibility of the non-sintered, buoyant filter media in combination with the popcorn shape may, in some embodiments, synergistically work together to mitigate crack formation in the filter bed, thereby enabling smaller particle sizes and, consequently, smaller pore sizes. This interlocking nature does not interfere with backflushing, as the particles will fluidize individually for clean up.

Further, in some embodiments, the non-sintered, buoyant filter media described herein having a popcorn shape may have a higher surface area that may contribute to higher filtration efficiencies (i.e., yielding effluent fluids with lower turbidity).

In some embodiments, the non-sintered, buoyant filter media described herein may have an anti-fouling surface modifier disposed on at least a portion of the surfaces of at least some of the particles. In some embodiments, the non-sintered, buoyant filter media described herein may comprise particles having no anti-fouling surface modifier and particles comprising an anti-fouling surface modifier. The anti-fouling surface modifier may, in some embodiments, be physically bound and/or chemically bound to the surface of the non-sintered, buoyant filter media described herein. Examples of anti-fouling surface modifiers that may be suitable for use in conjunction with the non-sintered, buoyant filter media described herein may, in some embodiments, include, but are not limited to, siloxanes, polymerized siloxanes, siloxane-based copolymers, polydimethylsiloxane, fluorochemicals, fluoropolymers, fluorocopolymers, polytetrafluoroethylene, polyvinylfluoride, polyvinylidiene fluoride, polychlorotrifluoroethylene, perfluoroalkoxy polymers, fluorinated ethylene-propylene, polyethylenetetrafluoroethylene, polyethylenechlorotrifluoroethylene, perfluoropolyether, polyethylene oxide, polyethylene glycols, polyvinyl pyrrolidone, polyacrylates, and the like, and any combination thereof.

In some embodiments, the non-sintered, buoyant filter media described herein may have any combination of a polymer (compositions and/or molecular weights) described herein, an average particle size described, and a particle shape described herein, and optionally include an anti-fouling surface modifier.

In some embodiments, the non-sintered, buoyant filter media described herein may be utilized in conjunction with a filtration apparatus and related methods that provides for compacting a filter bed during filtration and fluidizing the filter bed during backwash, the filter bed comprising the non-sintered, buoyant filter media described herein. As used herein, the term “compacting” refers to physically compressing filter media between solid materials (e.g., between plates or screens) to produce a compressed filter bed depth. The compressed filter may have a desired depth and shape that depends on, inter alia, the filtration apparatus configuration, the flow rate of the influent fluid, additional pressure applied to the solid materials during compaction, filter media composition, and the like. The use of solid materials for compaction may advantageously enable substantially uniform compaction of the filter media of the filter bed, which may consequently enable compression of the individual filter media particles so as to reduce the pore size of the filter bed. Further, the compacted filter beds described herein may mitigate movement of the individual filter media particles, thereby minimizing crack formation in the filter bed. It should be noted that a compacted filter bed described herein is distinguishable from a filter bed in filter apparatuses that use only fluid pressure in at least one direction to form the filter bed or are reliant on gravitational setting. In some embodiments, the bed depth under compaction will be smaller than if formed with fluid pressure alone.

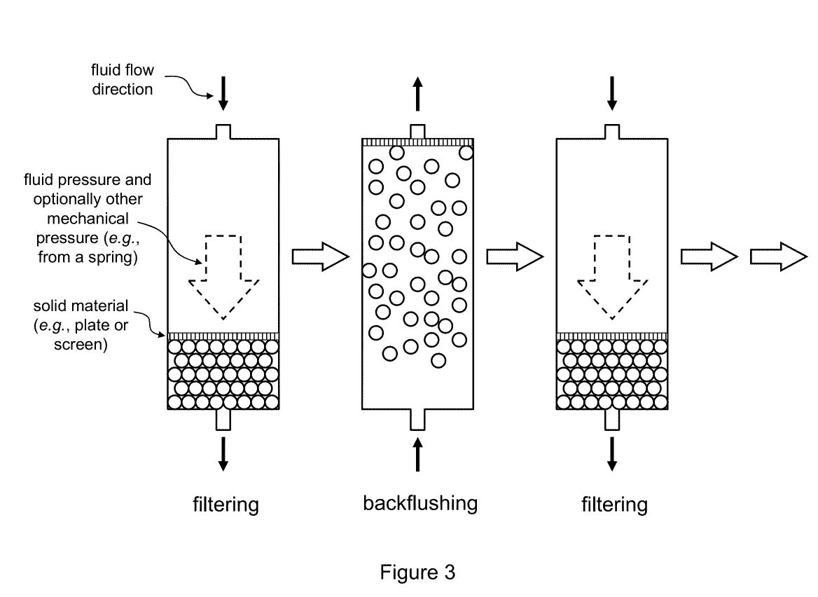

As illustrated in FIG. 3, some embodiments may involve filtering a first fluid for a filter bed that is mechanically compacted and comprises the non-sintered, buoyant filter media described herein so as to collect a plurality of contaminants of the first fluid; and backflushing a second fluid through the filter bed so as to fluidize the non-sintered, buoyant filter media and remove at least some of the contaminants from the non-sintered, buoyant filter media. In some embodiments, the second fluid may comprise at least a portion of the first fluid having passed through the filter bed. In some embodiments, the steps of filtering and backflushing may be performed multiple times in series, e.g., performing each at least 2 times, 3 times, 5 times, 10 times, hundreds of times, and so on over the like of the filter bed, including potentially thousands of times. In some embodiments, the cycling of the steps of filtering and backflushing may be continuous, intermittent, or a combination thereof.

In some embodiments, for example as illustrated in the examples below, the non-sintered, buoyant filter media described herein having a popcorn shape as compared to other shapes (or other filter media) may enable a higher filtration flow rate to yield a similar turbidity of the filtrate (i.e., similar efficacy), and likewise a similar filtration flow rate in combination to yield a lower turbidity of the filtrate (i.e., higher efficacy).

In some embodiments, the compacted filter bed described herein may comprise more than one type of non-sintered, buoyant filter media described herein. As used herein, a “type” of non-sintered, buoyant filter media may be distinguished by the composition, average particle size, bulk density, shape, an anti-fouling surface modifier or lack thereof, and the like, and any combination thereof. For example, a compacted filter bed described herein may comprise a first non-sintered, buoyant filter medium that is popcorn-shaped having a first average diameter and a second non-sintered, buoyant filter medium that is popcorn-shaped having a second average particle size, wherein the first average particle size and the second average particle size are different (e.g., by at least 10% to as much as 95%, including any subset thereof). In another example, a compacted filter bed described herein may comprise a first non-sintered, buoyant filter medium comprising polyethylene and that is popcorn-shaped having a first bulk density and a second non-sintered, buoyant filter medium that comprise polypropylene and that is potato-shaped having a second bulk density that is similar to that of the first bulk density.

In some embodiments, the compacted filter bed described herein may comprise two or more types of non-sintered, buoyant filter media that provides for a multimodal (e.g., bimodal, trimodal, and so on) particle size distribution where at least one mode has an average particle size of about 1 micron, 10 microns, 50 microns, 100 microns, 150 microns, 200 microns, and 250 microns to an upper limit of about 5000 microns, 2000 microns, 1000 microns, 750 microns, 500 microns, 400 microns, 300 microns, 250 microns, 200 microns, 150 microns, or 100 microns, and wherein the average particle size of at least one mode may range from any lower limit to any upper limit and encompasses any subset therebetween.

In some embodiments, the first fluid (i.e., the influent fluid) may be passed through the filter bed at a flow rate ranging from a lower limit of about 0.34 L/(sec*m² of filter bed), 1.36 L/(sec*m² of filter bed), or 6.8 L/(sec*m² of filter bed) to an upper limit of about 68 L/(sec*m² of filter bed), 34 L/(sec*m² of filter bed), 17 L/(sec*m² of filter bed), 6.8 L/(sec*m² of filter bed) (as measured with a 2.54 cm filter bed depth), and wherein the flow rate may range from any lower limit to any upper limit and encompasses any subset therebetween.

In some embodiments, the buoyant nature of the filter media may enable backflushing with a volume of fluid and/or at a flow rate less than filtering. In some embodiments, the second fluid (i.e., the backflush fluid) may be passed through the filter bed so as to fluidized the particles at a rate that ranges from about 100% less than the influent fluid flow rate, 90% less than the influent fluid flow rate, or 80% less than the influent fluid flow rate to an upper limit of about 60% less than the influent fluid flow rate, 40% less than the influent fluid flow rate, or 20% less than the influent fluid flow rate, and wherein the backflush fluid flow rate may range from any upper limit to any lower limit and encompasses any subset therebetween.

Influent fluid and backwashing flow rates may independently depend on, inter alia, the configuration of the filtration apparatus, composition of the filter bed, concentration of the contaminants in the influent fluid, the level or concentration of trapped contaminants in the filter bed, composition of the contaminants, and the like. One of ordinary skill in the art with the benefit of this disclosure should understand that the influent fluid and/or the backwashing fluid flow rates may, inter alia, depend on the filter bed depth, e.g., thinner bed depths may provide for higher flow rates and thicker bed depths may provide for lower flow rates. Accordingly, depending on the configuration the influent fluid and/or the backwashing fluid flow rates may be outside the ranges described in this disclosure.

In some instances, the contaminants filtered from the influent fluid may have a bulk density greater than the bulk density of the non-sintered, buoyant filter media described herein, which may allow for a more efficient separation of the filter media from the contaminants during backflushing. Further, some embodiments may involve gravitationally separating and removing the contaminants from the non-sintered, buoyant filter media described herein after backwashing and before compacting the non-sintered, buoyant filter media in a subsequent filtration cycle.

In some embodiments, examples of filtration apparatus suitable for use in conjunction with the non-sintered, buoyant filter media described herein may, in some embodiments, include, but are not limited to, a radial flow filtration apparatus, a downflow filtration apparatus, an upflow filtration apparatus, a crossflow filtration apparatus, and any hybrid thereof. In some embodiments, the filtration apparatus may be configured for a parallel filtration, a series filtration, and the like, and any hybrid thereof. Further, in some embodiments, the filtration apparatus may comprise a pre-filter that may optionally comprise the non-sintered, buoyant filter media described herein.

In some embodiments, the filter bed described herein may have a depth of about 1 mm or greater. For example, the filter bed may have a depth ranging from a lower limit of about 1 mm, 5 mm, 25 mm, or 10 cm to an upper limit of about 5 m, 1 m, 50 cm, or 25 cm, and wherein the depth may range from any lower limit to any upper limit and encompasses any subset therebetween. It should be understood by one of ordinary skill in the art that the filter bed depth may depend upon, inter alia, the configuration and size of the filtration apparatus and may, in some embodiments, be outside the ranges described herein.

In some embodiments, the compacted filter bed described herein may further comprise additional filter media (which may be buoyant or non-buoyant (e.g., having a bulk density ranging from about 1.00 g/cm³ to about 7.0 g/cm³)). Examples of additional filter media may include, but are not limited to, fibers, thermoplastic particles, foamed particles, pumice, hollow glass beads, ceramic particles, sand, glass beads, diatomaceous earth, activated carbon, anthracite coal, slag, zeolite materials, antimicrobial particles (e.g., silver particles), and the like, any hybrid thereof, and any combination thereof. In some embodiments, the fibers may have an aspect ratio of greater than about 1. In some embodiments, the fibers may have an aspect ratio ranging from a lower limit of about 2, 5, 10, 50, or 100 to an upper limit of about 1000, 750, 500, or 100, and wherein the aspect ratio may range from any lower limit to any upper limit and encompasses any subset therebetween. In some embodiments, the fibers may have an average diameter ranging from a lower limit of about 100 nm, 1 micron, 5 microns, or 10 microns to an upper limit of about 50 microns, 25 microns, or 10 microns, and wherein the average diameter may range from any lower limit to any upper limit and encompass any range therebetween.

In some embodiments, the compacted filter bed described herein may comprise two or more types of filter media as differentiated by bulk density such that at least one of the types of filter media comprise the non-sintered, buoyant filter media described herein. In some embodiments, the two or more types of filter media may form a striated filter bed based on the specific gravity and/or bulk density of the filter media. For example, a compacted filter bed described herein may comprise a first non-sintered, buoyant filter media having a bulk density of about 0.35 g/cm³ to about 0.9 g/cm³ and a second non-sintered, buoyant filter media having a bulk density of about 0.1 g/cm³ to about 0.3 g/cm³.

In another example, a compacted filter bed described herein may comprise a first non-sintered, buoyant filter media having a bulk density of about 0.35 g/cm³ to about 0.9 g/cm³, a second non-sintered, buoyant filter media having a bulk density of about 0.1 g/cm³ to about 0.3 g/cm³, and a third filter media being an additional non-sintered filter media described herein having a bulk density of greater than about 1.2 g/cm³ (e.g., about 1.2 g/cm³ to about 3.0 g/cm³). Without being limited by theory, it is believed that because the differences in bulk density may be designed as such, that after backflushing the particulates may settle back into a striated filter bed. In yet another example, a compacted filter bed described herein may comprise a first non-sintered, buoyant filter medium that is popcorn-shaped having a first average particle size and a second non-sintered, buoyant filter medium that is popcorn-shaped having a second average particle size that is different than the first average particle size (e.g., by at least 10% to as much as 95%, including any subset thereof) with the first and second non-sintered, buoyant filter medium having similar bulk densities (e.g., about 0.1 g/cm³ to about 0.3 g/cm³), so as to provide for a single striation, and the compacted filter bed may further comprise third filter media with a bulk density of greater than the bulk density of the first and second non-sintered, buoyant filter media (e.g., about 0.5 g/cm³ or greater), so as to provide for a second striation. One of ordinary skill in the art with the benefit of this disclosure should understand that striations may not be clearly defined (i.e., mixed) at the interface between the striated volumes that substantially comprise the filter media of a given bulk density.

In some embodiments, the bulk density of the filter media of the filter bed may be used in combination with particle size so as to yield a striated filter bed with each striation having a desired porosity. For example, a filter bed may comprise a first non-sintered, buoyant filter media having a bulk density of about 0.35 g/cm³ to about 0.9 g/cm³ and a particle size of about 30 microns to about 75 microns and a second non-sintered, buoyant filter media having a bulk density of about 0.1 g/cm³ to about 0.3 g/cm³ with a particle size of about 100 microns to about 250 microns.

To facilitate a better understanding of the present invention, the following examples of preferred or representative embodiments are given. In no way should the following examples be read to limit, or to define, the scope of the invention.

### EXAMPLES

### Example 1

The performance of four filter media was tested in a vertical filtration apparatus with a 2.4 cm filter bed depth having a solid, porous disc operably connected to a spring to provide at least some of the mechanical compaction to the filter bed. During backwashing cycles the backwash fluid flow rate and/or pressure compressed the spring and allowed the filter media to fluidize.

A filter fluid of water containing 0.79 g/L of ISO Course Test Dust was used as the influent fluid. The filter media tested included (FM1) sand, (FM2) diatomaceous earth (commercially available as CELATOM® SP from EP Minerals), (FM3) high molecular weight polyethylene particles with an average diameter of about 110 microns and a mixture of shapes similar to that shown in FIG. 1A, (FM4) ultrahigh molecular weight polyethylene particles with an average diameter of about 120 microns and a substantially potato shape similar to that shown in FIG. 1B, (FM5) ultrahigh molecular weight polyethylene particles with an average diameter of about 125 microns and a popcorn-shape similar to that shown in FIG. 1C, and (FM6) ultrahigh molecular weight polyethylene particles with an average diameter of about 120 microns, a substantially potato shape, and a hydrophilically treated surface (as an example of an anti-fouling surface treatment).

The filter fluid was passed through the filter bed with a back pressure of 34.5 kPag. To compare the efficacy of the various filter media, the turbidity of the effluent and the flow rate were measured. The flow rate is reported herein as the flow rate after 1.2 L of filter fluid had passed through the filter bed.

TABLE 1

| | Effluent | Flow Rate |
|---|---|---|
| Sample | Turbidity (NTU) | (L/sec) |
| FM1 | 211 | 0.02 |
| FM2 | 1.5 | 3.8 × 10⁻³ |
| FM3 | 1.3 | 2.3 × 10⁻³ |
| FM4 | 0.8 | 1.5 × 10⁻³ |
| FM5 | 0.6 | 6.8 × 10⁻³ |
| FM6 | 0.8 | 1.5 × 10⁻³ |

This example illustrates that the use of non-sintered, buoyant filter media described herein synergistically provides for a filter effluent with a lower turbidity (i.e., increased filter efficacy) while also allowing for higher flow rates, which in turn enables filters with high efficacy and high throughput. Further, the popcorn-shaped, non-sintered, buoyant filter media appears to synergistically provide for both higher flow rate and lower turbidity.

### Example 2

The performance of mixed filter media was tested in the filtration apparatus of Example 1 with a 2.54 cm filter bed depth and a filter fluid of water containing 0.79 g/L of ISO Course Test Dust. The filter media tested included FM4, FM5, (FM7) fibers comprising polyethylene having a denier of about 10 and an average length of about 0.5 inches, (FM8) ultrahigh molecular weight polyethylene particles with an average diameter of about 200 microns and a popcorn-shape, and (FM9) ultrahigh molecular weight polyethylene particles with an average diameter of about 32 microns and a popcorn-shape.

The filter fluid was passed through the filter bed with a back pressure of 34.5 kPag. To compare the efficacy of the various filter media, the turbidity of the effluent and the flow rate were measured. The flow rate is reported herein as the flow rate after 1.2 L of filter fluid had passed through the filter bed.

TABLE 2

| | Effluent | Flow Rate |
|---|---|---|
| Sample | Turbidity (NTU) | (L/sec) |
| FM4 | 0.8 | 1.5 × 10⁻³ |
| FM5 | 0.6 | 6.8 × 10⁻³ |
| FM7 | 94 | 4.9 × 10⁻² |
| 3:1 by wt of | 2.2 | 1.8 × 10⁻² |
| FM4:FM7 | | |
| 1:1 by wt of | 1.2 | 6.8 × 10⁻³ |
| FM4:FM5 | | |
| 1:1 by wt of | 1.7 | 8.7 × 10⁻³ |
| FM5:FM8 | | |
| 1:2 by wt of | 2.7 | 1.1 × 10⁻² |
| FM5:FM8 | | |
| 2:1 by wt of | 0.2 | 4.9 × 10⁻³ |
| FM5:FM9 | | |

This example illustrates that combinations of filter media described herein can be used to achieve desirable flow rates and effluent turbidities. Further, combinations of sizes of non-sintered, buoyant filter media (e.g., 2:1 by wt of FM5:FM9) may enhance the filtration efficacy (e.g., lower turbidity) without significant sacrifice in flow rate (e.g., as compared to FM5). Further, mixtures of two popcorn-shaped, non-sintered, buoyant filter media appears to provide for both higher flow rate and lower turbidity and allow for tailoring of the flow rate and filtration efficacy, which may be useful in certain applications.

### Example 3

The ability to cycle through filtration and backflush steps was tested with a plurality of filter media using the filtration apparatus of Example 1 with a 2.54 cm filter bed depth and a filter fluid of water containing 0.79 g/L of ISO Course Test Dust. The filter fluid was passed through the filter bed with a back pressure of 34.5 kPag. The backflush was performed at flow rates of about 0.094 L/sec to about 0.126 L/sec.

To compare the efficacy of the various filter media after backflushing, the turbidity of the effluent and the flow rate were measured. The flow rate is reported herein as the flow rate after 1.2 L of filter fluid had passed through the filter bed.

TABLE 3

| | Effluent | Flow Rate |
|---|---|---|
| Sample | Turbidity (NTU) | (L/sec) |
| FM5 | 0.6 | 6.8 × 10⁻³ |
| (1st filtration) | | |
| FM5 | 1.4 | 4.9 × 10⁻³ |
| (2nd filtration after backflush) | | |
| 1:1 by wt of FM4:FM5 | 1.2 | 6.8 × 10⁻³ |
| (1st filtration) | | |
| 1:1 by wt of FM4:FM5 | 2.2 | 3.4 × 10⁻³ |
| (2nd filtration after backflush) | | |

This example illustrates that the non-sintered, buoyant filter media described herein is suitable for multiple cycles of filtration and backflushing.

### Example 4

The ability to challenge filtration with increasing concentrations of contaminants was tested with two filter media (FM5 and a 2:1 by weight FM5:FM9) in the filtration apparatus of Example 1 with a 2.54 cm filter bed and a filter fluid of water containing varying concentrations of ISO Course Test Dust for each gallon passed through the filter. To compare the filtration efficiency, the turbidity of the effluent and the flow rate were measured. The flow rate is reported herein as the flow rate after 1.2 L of filter fluid had passed through the filter bed.

TABLE 4

| | | Back | Effluent | |
|---|---|---|---|---|
| | Conc. of | Pressure | Turbidity | Flow Rate |
| Sample | Dust (g/L) | (kPa) | (NTU) | (L/sec) |
| FM5 | 0.79 | 34.5 | 0.6 | 6.8 × 10⁻³ |
| FM5 | 1.06 | 69 | 0.4 | 2.7 × 10⁻³ |
| FM5 | 1.06 | 69 | 0.3 | 1.5 × 10⁻³ |
| 2:1 by wt of | 0.79 | 34.5 | 0.2 | 4.9 × 10⁻³ |
| FM5:FM9 | | | | |
| 2:1 by wt of | 1.06 | 69 | 0.2 | 3.4 × 10⁻³ |
| FM5:FM9 | | | | |
| 2:1 by wt of | 1.06 | 69 | 0.2 | 2.7 × 10⁻³ |
| FM5:FM9 | | | | |
| 2:1 by wt of | 1.06 | 103 | 0.1 | 1.5 × 10⁻³ |
| FM5:FM9 | | | | |

This example illustrates that as the non-sintered, buoyant filter media described herein filters contaminants (i.e., traps particulates in the pores) the pressure to achieve a desired flow rate increases. However, the turbidity decrease, even at the higher pressures, may indicate that mechanical compaction is mitigating crack formation and, in this example, the popcorn shape of the filter media may be further enhancing such minimization.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
filtering a first fluid through a filter bed that is compacted, the filter bed comprising a non-sintered, buoyant filter medium that is mechanically compacted; and
backflushing a second fluid through the filter bed so as to fluidize the non-sintered, buoyant filter medium.

2. The method of claim 1, wherein the non-sintered, buoyant filter medium comprises particles having a shape selected from the group consisting of spherical, substantially spherical, ovular, substantially ovular, prolate, globular, potato, substantially potato, discus, platelet, flake, acicular, polygonal, randomly shaped, and any hybrid thereof.

3. The method of claim 1, wherein the non-sintered, buoyant filter medium comprises particles having a popcorn-shape.

4. The method of claim 1, wherein the non-sintered, buoyant filter medium comprises a plurality of particles that comprise a polymer selected from the group consisting of polyethylene, polypropylene, polybutylene, polyethylene-co-polybutylene, polyethylene-co-polypropylene, polypropylene-co-polybutylene, and any blend thereof.

5. The method of claim 4, wherein the polymer is high to ultrahigh molecular weight.

6. The method of claim 4, wherein the non-sintered, buoyant filter medium comprises the particles are composite particles and further comprise an active agent selected from the group consisting of activated carbon, graphite, an ion exchange resin, a silicate, a molecular sieve, a silica gel, activated alumina, a zeolite, a mineral material, perlite, sepiolite, magnesium silicate, Fuller's Earth, and any combination thereof.

7. The method of claim 1, wherein the non-sintered, buoyant filter medium comprises particles having an anti-fouling surface modification.

8. The method of claim 1, wherein the non-sintered, buoyant filter medium comprises particles having a bulk density of less than about 1.0 g/cm³.

9. The method of claim 1, wherein the non-sintered, buoyant filter medium comprises particles having a bulk density between about 0.10 g/cm³ and about 0.30 g/cm³.

10. The method of claim 1, wherein the non-sintered, buoyant filter medium comprises particles having an average particle size (d₅₀) between about 1 micron and about 5000 microns.

11. The method of claim 1, wherein the non-sintered, buoyant filter medium comprises particles having an average particle size (d₅₀) in at least one dimension between about 1 micron and about 250 microns.

12. The method of claim 1, wherein the non-sintered, buoyant filter medium is a first non-sintered, buoyant filter medium having a first average particle size, wherein the compacted filter bed further comprises a second non-sintered, buoyant filter medium having a second average particle size, and wherein the first average particle size is greater than the second average particle size, thereby yielding a bimodal average particle size distribution.

13. The method of claim 1, wherein the non-sintered, buoyant filter medium is a first non-sintered, buoyant filter medium having a first bulk density, and wherein the compacted filter bed further comprises a second non-sintered, buoyant filter medium having a second bulk density, and wherein the first bulk density is greater than the second bulk density.

14. The method of claim 13, wherein the filter bed is striated.

15. The method of claim 1, wherein the non-sintered, buoyant filter medium is a first non-sintered, buoyant filter medium having a first shape, and wherein the compacted filter bed further comprises a second non-sintered, buoyant filter medium having a second shape, and wherein the first shape is different than the second shape.

16. The method of claim 15, wherein the first shape is popcorn and the second shape is potato.

17. The method of claim 1, wherein the filter bed further comprises at least one selected from the group consisting of a fiber, a thermoplastic particle, a foamed particle, pumice, a hollow glass bead, a ceramic particle, sand, a glass bead, diatomaceous earth, activated carbon, anthracite coal, slag, a zeolite material, an antimicrobial particle, a silver particle, any hybrid thereof, and any combination thereof.

18. The method of claim 1, wherein the filter bed further comprises fibers having an aspect ratio of greater than about 1.

19. The method of claim 1, wherein the filter bed further comprises fibers having an aspect ratio of about 2 to about 1000.

20. The method of claim 1, wherein the filter bed is at least a portion of a filtration apparatus selected from the group consisting of a radial flow filtration apparatus, an upflow filtration apparatus, a downflow filtration apparatus, a crossflow filtration apparatus, and any hybrid thereof.

21. The method of claim 1, wherein the filter bed is at least a portion of a filtration apparatus selected from the group consisting of a parallel filtration apparatus, a series filtration apparatus, and any hybrid thereof.

22. The method of claim 1, wherein the filter bed that is compacted has a depth during filtering of about 1 mm to about 5 m.

23. The method of claim 1, wherein filtering the first fluid through the filter bed occurs at a flow rate of between about 0.34 L/(sec*m2 of filter bed) and about 68 L/(sec*m2 of filter bed) as measured with a 2.54 cm filter bed depth.

24. The method of claim 23, wherein backflushing the second fluid through the filter bed occurs at a flow rate that is between about 100% less than and about 20% less than the flow rate of the first fluid through the filter bed.

25. The method of claim 1 further comprising repeating the filtering and the backflushing in series a plurality of times.

26. A filtration apparatus comprising:
a compacted filter bed that comprises a non-sintered, buoyant filter medium; and
a configuration that allows for the non-sintered, buoyant filter medium to fluidize during backflush.

27. The filtration apparatus of claim 26, wherein the non-sintered, buoyant filter medium comprises particles having a shape selected from the group consisting of spherical, substantially spherical, ovular, substantially ovular, prolate, globular, potato, substantially potato, discus, platelet, flake, acicular, polygonal, randomly shaped, and any hybrid thereof.

28. The filtration apparatus of claim 26, wherein the non-sintered, buoyant filter medium comprises particles having a popcorn-shape.

29. The filtration apparatus of claim 26, wherein the non-sintered, buoyant filter medium comprises a plurality of particles that comprise a polymer selected from the group consisting of polyethylene, polypropylene, polybutylene, polyethylene-co-polybutylene, polyethylene-co-polypropylene, polypropylene-co-polybutylene, and any blend thereof.

30. The filtration apparatus of claim 29, wherein the polymer is high to ultrahigh molecular weight.

31. The filtration apparatus of claim 29, wherein the non-sintered, buoyant filter medium comprises the particles are composite particles and further comprise an active agent selected from the group consisting of activated carbon, graphite, an ion exchange resin, a silicate, a molecular sieve, a silica gel, activated alumina, a zeolite, a mineral material, perlite, sepiolite, magnesium silicate, Fuller's Earth, and any combination thereof.

32. The filtration apparatus of claim 26, wherein the non-sintered, buoyant filter medium comprises particles having an anti-fouling surface modification.

33. The filtration apparatus of claim 26, wherein the non-sintered, buoyant filter medium comprises particles having a bulk density of less than about 1.0 g/cm³.

34. The filtration apparatus of claim 26, wherein the non-sintered, buoyant filter medium comprises particles having a bulk density between about 0.10 g/cm³ and about 0.30 g/cm³.

35. The filtration apparatus of claim 26, wherein the non-sintered, buoyant filter medium comprises particles having an average diameter in at least one dimension between about 1 micron and about 5000 microns.

36. The filtration apparatus of claim 26, wherein the non-sintered, buoyant filter medium is a first non-sintered, buoyant filter medium having a first average particle size, wherein the compacted filter bed further comprises a second non-sintered, buoyant filter medium having a second average particle size, and wherein the first average particle size is greater than the second average particle size, thereby yielding a bimodal average particle size distribution.

37. The filtration apparatus of claim 26, wherein the non-sintered, buoyant filter medium is a first non-sintered, buoyant filter medium having a first bulk density, and wherein the compacted filter bed further comprises a second non-sintered, buoyant filter medium having a second bulk density, and wherein the first bulk density is greater than the second bulk density.

38. The filtration apparatus of claim 37, wherein the filter bed is striated.

39. The filtration apparatus of claim 26, wherein the non-sintered, buoyant filter medium is a first non-sintered, buoyant filter medium having a first shape, and wherein the compacted filter bed further comprises a second non-sintered, buoyant filter medium having a second shape, and wherein the first shape is different than the second shape.

40. The filtration apparatus of claim 39, wherein the first shape is popcorn and the second shape is potato.

41. The filtration apparatus of claim 26, wherein the compacted filter bed further comprises at least one selected from the group consisting of a fiber, a thermoplastic particle, a foamed particle, pumice, a hollow glass bead, a ceramic particle, sand, a glass bead, diatomaceous earth, activated carbon, anthracite coal, slag, a zeolite material, an antimicrobial particle, a silver particle, any hybrid thereof, and any combination thereof.

42. The filtration apparatus of claim 26, wherein the compacted filter bed further comprises fibers having an aspect ratio of greater than about 1.

43. The filtration apparatus of claim 26, wherein compacted the filter bed further comprises fibers having an aspect ratio of about 2 to about 1000.

44. The filtration apparatus of claim 26, wherein the filtration apparatus is selected from the group consisting of a radial flow filtration apparatus, an upflow filtration apparatus, a downflow filtration apparatus, a crossflow filtration apparatus, and any hybrid thereof.

45. The filtration apparatus of claim 26, wherein the filtration apparatus is selected from the group consisting of a parallel filtration apparatus, a series filtration apparatus, and any hybrid thereof.

46. The filtration apparatus of claim 26, wherein the compacted filter bed has a depth of about 1 mm to about 5 m.
